(19) United States
(12) Patent Application Publication
(10) Pub. No.: US 2016/0381499 A1
(43) Pub. Date: Dec. 29, 2016

(54) PERSONAL LUGGAGE LOCATOR DEVICE, SYSTEM, AND PROCESSES

(71) Applicants: MIHAI RADU DRAGHICI, KIRKLAND, WA (US); ALEXANDER GEORGE DRAGHICI, SAN ANTONIO, TX (US); GREG HANNLEY, MALIBU, CA (US)

(72) Inventors: MIHAI RADU DRAGHICI, KIRKLAND, WA (US); ALEXANDER GEORGE DRAGHICI, SAN ANTONIO, TX (US); GREG HANNLEY, MALIBU, CA (US)

(21) Appl. No.: 15/148,939

(22) Filed: May 6, 2016

Related U.S. Application Data
(60) Provisional application No. 62/183,414, filed on Jun. 23, 2015.

(51) Int. Cl. H04W 4/02; G01S 19/42; G08B 21/24

(52) U.S. Cl. CPC H04W 4/02; G08B 21/24; G01S 19/42

(57) ABSTRACT

A personal luggage locator device, system, and processes for controlling this device are disclosed. The personal luggage locator device and system allows a traveler to track his or her luggage when traveling by packing the personal luggage locator device in the luggage and tracking the location of the luggage using a mobile device that receives location information about the luggage from at least one of a global positioning system (GPS) and a Bluetooth communication connection to the personal luggage locator device.

### CLAIM OF BENEFIT TO PRIOR APPLICATION

This application claims benefit to U.S. Provisional Patent Application 62/183,414, entitled “PERSONAL LUGGAGE LOCATOR DEVICE AND SYSTEM FOR CONTROLLING PERSONAL LUGGAGE LOCATOR DEVICE,” filed Jun. 23, 2015. The U.S. Provisional Patent Application 62/183,414 is incorporated herein by reference.

### BACKGROUND

Embodiments of the invention described in this specification relate generally to travel devices, and more particularly, to personal luggage locator devices, systems, and processes.

Travelers typically have no knowledge of where their baggage is during travel on airlines and through airports. Once the baggage leaves the airline check-in counter and rolls away on the conveyor belt, a passenger will not see his or her bags again until arrival at the destination and pick up at baggage claim (assuming the bags do not get lost along the way).

Currently, airlines use several types of sticker tags with barcode labels to scan and track passenger baggage. But this system does not share the location or status of the bags with the traveler, thus the traveler remains oblivious and has to wonder every time they fly if their bags are still going to be waiting for them at their destination.

Also, at the baggage claim carousel in most airports there is a congestion of people who all try to crowd around the edge of the carousel trying to wait and identify their bags.

Therefore, what is needed is a way for any passenger to track and locate their own baggage when arriving at a travel destination.

### BRIEF DESCRIPTION

Embodiments of the disclosed invention include a personal luggage locator device, a personal luggage locator system, and personal luggage locator device processes. In some embodiments, the personal luggage locator device allows a person to locate luggage that is temporarily in the custody of another person or entity during travel by packing the personal luggage locator device in the luggage and tracking the location of the luggage using a mobile device that receives location information about the luggage from at least one of a global positioning system (GPS) and a near field wireless communication connection to the personal luggage locator device.

In some embodiments, the personal luggage locator device is used in connection with the personal luggage locator system. The personal luggage locator system includes the personal luggage locator device, a mobile device that includes a mobile application for locating a luggage item in which the personal luggage locator device resides, a cloud-network luggage locator service and cloud database with personal luggage locator registration information accessible to the mobile device by a server computing device that runs a luggage locator application for retrieving registration information from the cloud database and locating the luggage item in which the personal luggage locator device resides.

In some embodiments, the personal luggage locator device processes are performed by the personal luggage locator device in connection with the personal luggage locator system. The personal luggage locator device processes include (i) a personal luggage locator device activation and pairing process for pairing a personal luggage locator device with a mobile device and activating the personal luggage locator device in relation to a trip and (ii) an active trip personal luggage locator device process.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a block diagram of a personal luggage locator device in some embodiments.

FIG. 2 conceptually illustrates a personal luggage locator system in some embodiments.

FIG. 3 conceptually illustrates a schematic diagram of communication tracking between a mobile device that is paired to a personal luggage locator device in some embodiments.

FIG. 4 conceptually illustrates a personal luggage locator device activation and pairing process in some embodiments for pairing a personal luggage locator device with a mobile device and activating the personal luggage locator device in relation to a trip.

FIG. 5 conceptually illustrates an active trip personal luggage locator device process in some embodiments.

FIG. 6 conceptually illustrates a schematic diagram of a process for adding trips and setting travel information in a personal luggage locator device in some embodiments.

FIG. 7 conceptually illustrates an active trip personal luggage locator device process in some embodiments.

FIG. 8 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several uses in which a person locates items that are temporarily in the custody of another person or entity.

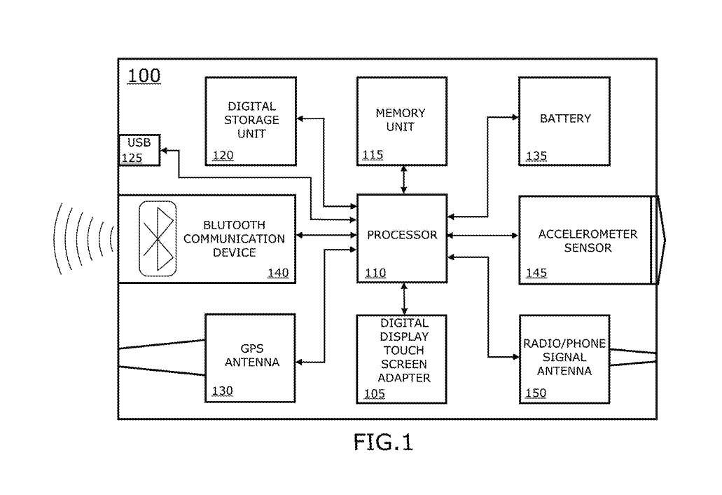

Some embodiments of the invention include a novel personal luggage locator device, a personal luggage locator system, and processes that allow a traveler to track his or her luggage when traveling. In some embodiments, the personal luggage locator device allows a person to locate luggage that is temporarily in the custody of another person or entity during travel by packing the personal luggage locator device in the luggage and tracking the location of the luggage using a mobile device that receives location information about the luggage from at least one of a global positioning system (GPS) and a near field wireless communication connection to the personal luggage locator device. In some embodiments, the near field wireless communication connection is a Bluetooth® wireless communication connection. The Bluetooth® word mark and logos (as shown in FIG. 1) are registered trademarks owned by Bluetooth SIG, Inc.

In this specification, the word “luggage” is used to describe a container that holds items during travel, and is hereinafter referred to interchangeably as “luggage”, “personal luggage”, “bag”, “bags”, “travel bag”, “travel bags”, “baggage”, “checked baggage”, and other such well-known travel container terms.

In this specification, there are descriptions of processes and methods that are performed by software running on a personal luggage locator device and/or on a traveler's mobile computing device (e.g., smartphone) in order for the traveler to interact with a cloud-based personal luggage locator service and an associated cloud-network database that includes registration information of registered personal luggage locator devices. However, it should be noted that for the purposes of the embodiments described in this specification, the word “method” is used interchangeably with the word “process”. Methods are described, therefore, by reference to example processes that conceptually illustrate process steps for pairing a personal luggage locator device with a mobile device and activating the personal luggage locator device in relation to a trip and/or steps of an active trip personal luggage locator device process.

As stated above, normally travelers have practically no knowledge of where their baggage is during travel on airlines and through airports. Once the bags are out of the passenger's control, the passenger will not see their bags again until they pick them up at the destination. Although airlines have their own baggage tracking systems (e.g., sticker tags with barcode labels), travelers are not provided location or status information related to their bags. Thus, travelers typically remain oblivious to the whereabouts of their bags and have to wonder every time they fly if their bags are still going to be waiting for them at their destination. Even when they are waiting for the travelers at their destination, baggage claim carousels in most airports are usually highly congested with other travelers, making it difficult to even see whether or not the traveler's own bags are moving down the conveyor belt. Embodiments of the personal luggage locator device and system described in this specification solve such problems by using a personal luggage locator device that a traveler packs inside each bag and downloads the device control mobile smartphone application. The application syncs with each device via Bluetooth® and the passenger registers each device with their trip flight information.

Embodiments of the personal luggage locator device and system described in this specification differ from and improve upon existing options because, currently, airlines use a general system with several types of sticker tags having barcode labels to scan and track passenger baggage. However, this system does not share the location or status of the bags with the traveler, thus, the traveler remains oblivious and has to wonder every time they fly if their bags are still going to be waiting for them at their destination.

The personal luggage locator device and system of the present disclosure generally works to allow a traveler to track his or her bags and find them at arrival. For example, to use the personal luggage locator device and system, a passenger traveling from Seattle, WA to New York, NY may have three bags to check-in at the airport. The passenger can order personal luggage locator devices online and receive them at home or, once they arrive at the airport, they can visit an electronic vending machine which has personal luggage locator devices for sale. Personal luggage locator devices obtained from electronic vending machines at airports would have been screened and approved by TSA agents prior to being placed into the electronic vending machines. After purchasing or receiving the three personal luggage locator devices, the passenger would then open each TSA sealed package that contains a personal luggage locator device. The passenger scans a QR code printed on any one of the devices to automatically download a smartphone application onto their mobile phone. The passenger connects each device via Bluetooth® to their smartphone. Then, the passenger launches the mobile app to begin the device and user registration process over Bluetooth® network technology.

After the passenger successfully registers all the personal luggage locator devices, which includes creating a new user account and activating the Internet connectivity plan for each device, they add their upcoming flight using the mobile application and then sync the data over the Internet to each personal luggage locator device. Then, the passenger inserts one personal luggage locator device inside each baggage item they plan to check-in at the airline counter. After going through TSA security and arriving at the departure gate an hour before boarding time, the passenger can access the mobile app and check the status of their bags.

The mobile application will display an approximate altitude, distance from the passenger, and other statistical information for each of their bags that contains a personal luggage locator device. This statistical information is only available up until boarding time is announced, after which the personal luggage locator devices automatically turn themselves into “Airplane Mode” and stop all external data communications and go into hibernation to save battery life. About ten minutes after landing at the destination airport, assuming the airplane arrived on time, the personal luggage locator devices wake up from hibernation and perform a quick status check to verify the plane has arrived at the destination and is on the ground.

The passenger will launch the smartphone mobile application and the software will communicate over the Internet through the web API to check and read if the personal luggage locator devices have started to sync their GPS and altitude data again. If so, the application will display decision making content and statistics which indicate the approximate distance away that each bag is and about how long it could take for the bags to arrive at the baggage claim carousel where the passenger is currently waiting.

Instead of crowding around the edge of the baggage claim carousel, passengers using personal luggage locator devices would know that the bags are still on the plane and may not arrive for an estimated amount of time based on the information provided by the mobile application (e.g., approximately another thirty minutes), and so they have enough time to go do something else instead of waiting near the carousel.

To make the personal luggage locator device and system of the present disclosure, a person may put together the elements described above, and use the device in standalone by inserting into a luggage item of the person. Alternatively, a person could have the device manufactured into the luggage design and construction itself.

Some examples of additional uses of the personal luggage locator device and system may include, without limitation: (a) tracking your furniture when you hire movers, (b) track your vehicle when you have it shipped somewhere, (c) track a water vessel that is being delivered somewhere, and (d) track a package that is shipped somewhere.

Several more detailed embodiments are described below. Section I describes a personal luggage locator device. Section II describes a cloud-network architecture of an exemplary personal luggage locator system. Section III describes several personal luggage locator device processes. Lastly, Section IV describes an electronic system that implements some embodiments of the invention.

### I. Personal Luggage Locator Device

In some embodiments, the personal luggage locator device includes a processor, a memory unit, a digital storage unit, a universal serial bus (USB) port, a global positioning system (GPS) antenna, a battery, a Bluetooth® communication device, an accelerometer sensor, and a radio/phone signal antenna. In some embodiments, the personal luggage locator device includes a digital display touch screen. In some embodiments, the personal luggage locator device includes an outer protective shell that encapsulates the processor, the memory unit, the digital storage unit, the USB port, the GPS antenna, the battery, the Bluetooth® communication device, the accelerometer sensor, and the radio/phone signal antenna. In some embodiments, the outer protective shell includes a panel cutout that holds the digital display touch screen flush with the outer protective shell. In some embodiments, the outer protective shell includes an opening that exposes the USB port for external connection to a USB device.

By way of example, FIG. 1 conceptually illustrates a block diagram of a personal luggage locator device 100. As shown in this figure, the personal luggage locator device 100 includes a digital display touch screen 105, a processor 110, a memory unit 115, a digital storage unit 120, a USB port 125, a GPS antenna 130, a battery 135, a Bluetooth® communication device 140, an accelerometer sensor 145, and a radio/phone signal antenna 150.

The personal luggage locator device 100 shown in this figure is a standalone small form factor device that has a small touch-sensitive digital display 105. In some embodiments, the digital display is not a touch-sensitive display screen. In some embodiments, the personal luggage locator device 100 does not include a digital display. The digital display touch screen 105 shown in FIG. 1 is not representative of an actual size or relative size of a digital display which may be deployed with the personal luggage locator device 100, but instead is shown in block diagram format so as not to obscure other elements of the personal luggage locator device 100. Thus, a person skilled in the relevant art would appreciate that the digital display may have a panel size that is nearly as long and wide as the overall personal luggage locator device itself.

The personal luggage locator device 100 shown in this figure includes a Bluetooth® communication device 140 which allows a traveler with a Bluetooth® enabled mobile device to find the bag or luggage with the personal luggage locator device 100 inside. However, the Bluetooth® communication device 140 is only one way that the personal luggage locator device 100 uses wireless communication to determine the whereabouts of the bag or luggage of the traveler. Thus, the Bluetooth® communication device 140 is useful when, for example, the traveler has received a notification at the radio/phone signal antenna 150 that the bag or luggage is being made available at the baggage claim carousel (e.g., being removed from the airplane and put onto the baggage claim carousel conveyor belt). the Bluetooth® networking component for communication with a mobile device (smartphone)

In some embodiments, the ability to receive signals at the radio/phone signal antenna 150 is based on an embedded SIM card (not shown). The embedded SIM card provides Internet connectivity or cellular reception for voice calls (or both). When the SIM card supports unbounded geographic operation, then the SIM card provides worldwide Internet connectivity. In this way, much of the information received at the traveler's mobile device is retrieved via the Internet when the personal luggage locator device 100 is not within a communicable range for effective Bluetooth® communication.

In some embodiments, the battery 135 comprises a lithium-ion battery. In some embodiments, the personal luggage locator device 100 draws electrical power from the lithium-ion battery. In some embodiments, the lithium-ion battery is rechargeable via the USB port 125. The USB port 125 of some embodiments supports the addition of an external USB persistent storage device. Such external USB persistent storage device can be used, for example, to provide specialized information about a flight plan or names at a destination.

Whether or not an external USB persistent storage device is used, the personal luggage locator device includes the digital storage unit 120. In some embodiments, the digital storage unit 120 is solid state hard drive. In some embodiments of the personal luggage locator device 100, the solid state hard drive is useful for reliability in extreme conditions.

In some embodiments, the personal luggage locator device 100 includes a proprietary computer motherboard design (not shown in FIG. 1). In some embodiments, the personal luggage locator device 100 runs an embedded software program on the processor 110. In some embodiments, the embedded software program performs sets of instructions for (a) controlling hibernation mode and airplane mode of the personal luggage locator device 100, (b) managing power usage and battery life, (c) sending GPS coordinates and altitude data to the central database via the web API interface, and (d) managing flight plan data and internal hardware operation schedules.

In some embodiments, the personal luggage locator device creates a flight schedule from the flight plan data and uses this flight schedule to control when it is sending GPS coordinates and altitude data to the central database. In some embodiments, the personal luggage locator device automatically turns off GPS communication and enables “Airplane Mode” when the flight's gate boarding time begins. During the flight, the personal luggage locator device of some embodiments goes into hibernation mode to save battery life. In some embodiments, the personal luggage locator device automatically wakes up ten minutes after the flight is scheduled to land at the destination airport.

In some embodiments, the personal luggage locator device performs a status check upon automatic wake-up. This is important in case the flight has been delayed and does not arrive on time. When a quick status check is performed, the personal luggage locator device 100 calculates a current altitude and current GPS coordinates and compares the current GPS coordinates with GPS coordinates known to be associated with the destination airport. In some embodiments, the GPS antenna 130 is a GPS receiver that can determine the current altitude by trilateration with four or more GPS satellites. Thus, if the scheduled landing time has already passed and the personal luggage locator device is higher than ground level or the current GPS coordinates and the GPS coordinates known to be associated with the destination airport differ by more than a margin of proximity (e.g., defined according to known sizes of airports), then the personal luggage locator device goes back into hibernation mode. In some embodiments, the personal luggage locator estimates an updated arrival time at the destination when the plane has not landed yet and the flight is delayed. In some embodiments, the personal luggage locator device estimates the updated arrival time based on the distance between the current GPS coordinates and the GPS coordinates known to be associated with the destination airport.

On the other hand, the personal luggage locator device turns off that “Airplane Mode” setting when the current GPS coordinates are within the desired distance and at ground level ten minutes after landing time. In some embodiments, when the personal luggage locator device turns off “Airplane Mode”, the personal luggage locator device activates itself to send GPS coordinates and altitude again to the central database.

### II. Personal Luggage Locator System

In some embodiments, the personal luggage locator device 100 is used in connection with a personal luggage locator system. The personal luggage locator system of the present disclosure may be comprised of the following elements. This list of possible constituent elements is intended to be exemplary only and it is not intended that this list be used to limit the personal luggage locator system of the present application to just these elements. Persons having ordinary skill in the art relevant to the present disclosure may understand there to be equivalent elements that may be substituted within the present disclosure without changing the essential function or operation of the personal luggage locator system.

1. Personal luggage locator device

2. Smartphone mobile application

3. Central database

4. Web API

5. Messaging Center Service

The various elements of the personal luggage locator system of the present disclosure may be related in the following exemplary fashion. It is not intended to limit the scope or nature of the relationships between the various elements and the following examples are presented as illustrative examples only.

1) The personal luggage locator device is described in detail above by reference to FIG. 1.

2) The smartphone mobile application is a software program used to setup and control the personal luggage locator device 100 (which is described above by reference to FIG. 1) in the following ways, but not limited to: (a) user registration, (b) device activation, (c) flight plan scheduler, (d) hardware management, and (e) data communications.

3) The central database stores the communication data between the personal luggage locator device 100 and the smartphone mobile application. The central database may be a cloud-network database, a relational database management system with a relational data storage center, or an object-oriented database management system with an object database. The types of data contained are as follows, but not limited to: (a) altitude of the personal luggage locator device, (b) user profile, (c) GPS location information of the personal luggage locator device, and (d) other proprietary data.

4) The Web API is a proprietary interface that has the following responsibilities, but not limited to: (a) controls security access into the central database, (b) receives data from devices over the Internet, (c) creates/updates/deletes/transforms incoming data and data from the central database, and (d) sends data to devices over the Internet.

5) The messaging center service is a software and hardware system that distributes digital information over the Internet or phone networks to all the smartphone mobile applications which have been registered and are active in the central database.

As a preliminary matter, a personal luggage locator device needs to be registered and activated before it can be used. Before a personal luggage locator device can be activated, however, the personal luggage locator device needs to be paired to a mobile device of a traveler. For example, a traveler may have a smartphone with a personal luggage locator software application downloaded and installed, and a personal luggage locator device to put in a travel bag. The traveler would pair the personal luggage locator device to the smartphone, and then can safely put the registered and activated personal luggage locator device in a travel bag.

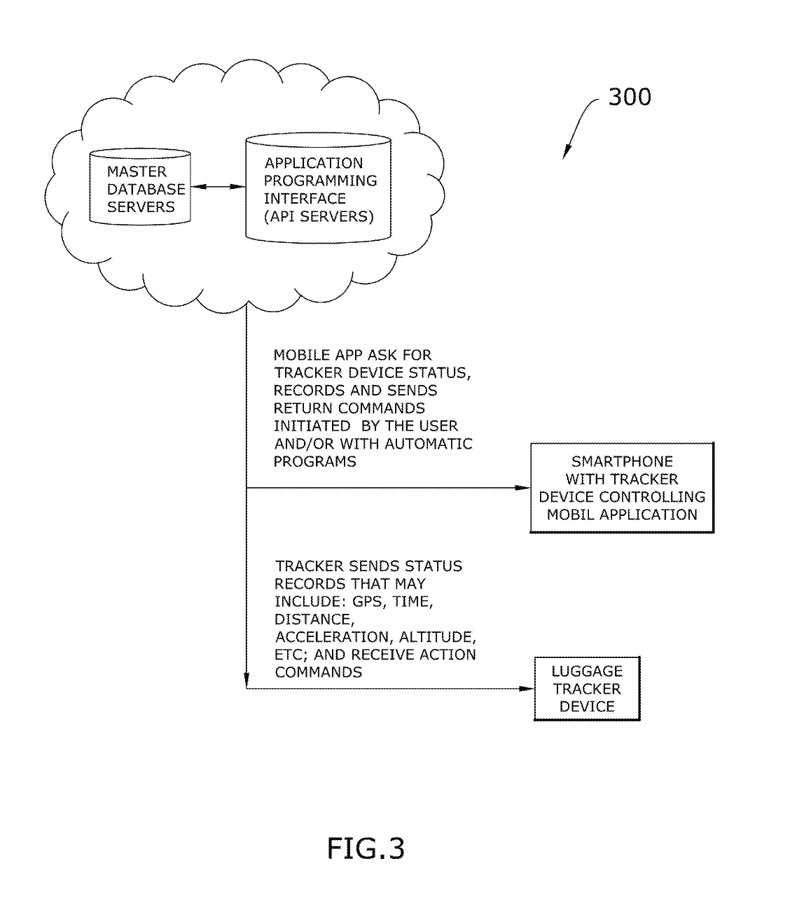

A conceptual illustration of such a pairing is shown by example in FIG. 3, which conceptually illustrates a schematic diagram of communication tracking 300 between a mobile device that is paired to a personal luggage locator device.

Once registered and activated, the personal luggage locator device 100 inside each bag will send GPS coordinates and altitude over the Internet to the central database. The smartphone application will calculate the distance between its own GPS coordinates and the passenger's personal luggage locator device coordinates and display the approximate distance to the passenger via the application interface.

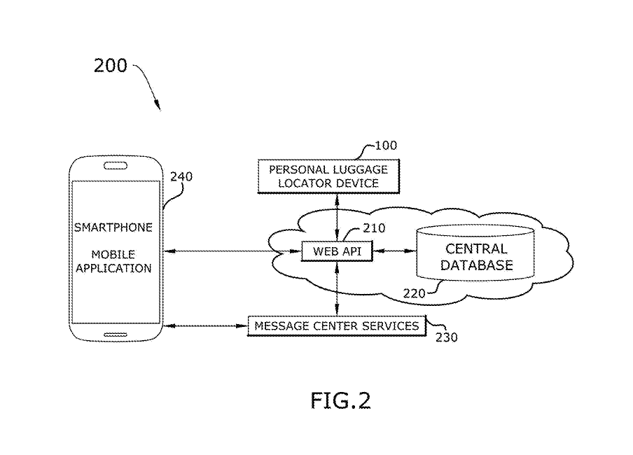

By way of example, FIG. 2 conceptually illustrates a personal luggage locator system 200 with such a personal luggage locator device 100. As shown in this figure, the personal luggage locator system 200 includes a web API 210 cloud-network luggage locator service and central database 220. The personal luggage locator system 200 is a cloud-network service that allows the personal luggage locator device 100 to connect to the web API 210 cloud-network luggage locator service from anywhere that the personal luggage locator device 100 can establish a network connection. One or more message center services 230 also connect to the web API 210 cloud-network luggage locator service and provide messaging to a mobile device 240 in connection with luggage that a person is tracking.

To track a personal luggage locator device 100 that is stored in a travel bag, suitcase, or other luggage item, the mobile device 240 includes a mobile application that connects to the web API 210 cloud-network luggage locator service. If the personal luggage locator device 100 is registered and activated, then the mobile application can request the location of the personal luggage locator device 100 from the web API 210 cloud-network luggage locator service. In making such a request, the mobile application sends a set of personal luggage locator registration information to the web API 210 cloud-network luggage locator service. Then the web API 210 cloud-network luggage locator service queries the central database 220 with the personal luggage locator registration information. If the personal luggage locator device 100 has arrived at the destination, and is ready for wireless communication (e.g., not in a dead zone, not in the air with the airplane, etc.), then it would send a message to the web API 210 cloud-network luggage locator service indicating its arrival at the destination. The web API 210 cloud-network luggage locator service would then record the arrival information in the central database 220 so that the traveler will know the status of the travel bag/travel item.

At the destination, wireless communication via the mobile device 240 can be used to determine the exact location of the travel bag with the personal luggage locator device 100 inside. For example, near field communication (NFC) can be established, Bluetooth® communication may be used, and/or GPS-based location information can be requested and received from a GPS system. In some embodiments, the mobile device 240 of the traveler includes a near field communication device, a Bluetooth® communication device, and/or a GPS communication device. In some embodiments, the mobile application locates the luggage item by at least one of (i) using the NFC device to communicate with a NFC device (not shown) of the personal luggage locator device 100, (ii) using the Bluetooth® communication device to communicate with the Bluetooth® communication communication device 140 of the personal luggage locator device 100, and (iii) using the GPS antenna 130 communication device to communicate with a global positioning system that has identified a location of the personal luggage locator device 100.

Thus, by using the personal luggage locator device 100 and the personal luggage locator system 200, travelers/passengers can more efficiently self-organize around the baggage claim carousel, based on the information via the mobile app, when the user interface display is showing that their bag is approaching.

### III. Personal Luggage Locator Processes

In some embodiments, the personal luggage locator device processes are performed by the personal luggage locator device in connection with the personal luggage locator system. The personal luggage locator device processes include (i) a personal luggage locator device activation and pairing process for pairing a personal luggage locator device with a mobile device and activating the personal luggage locator device in relation to a trip and (ii) an active trip personal luggage locator device process.

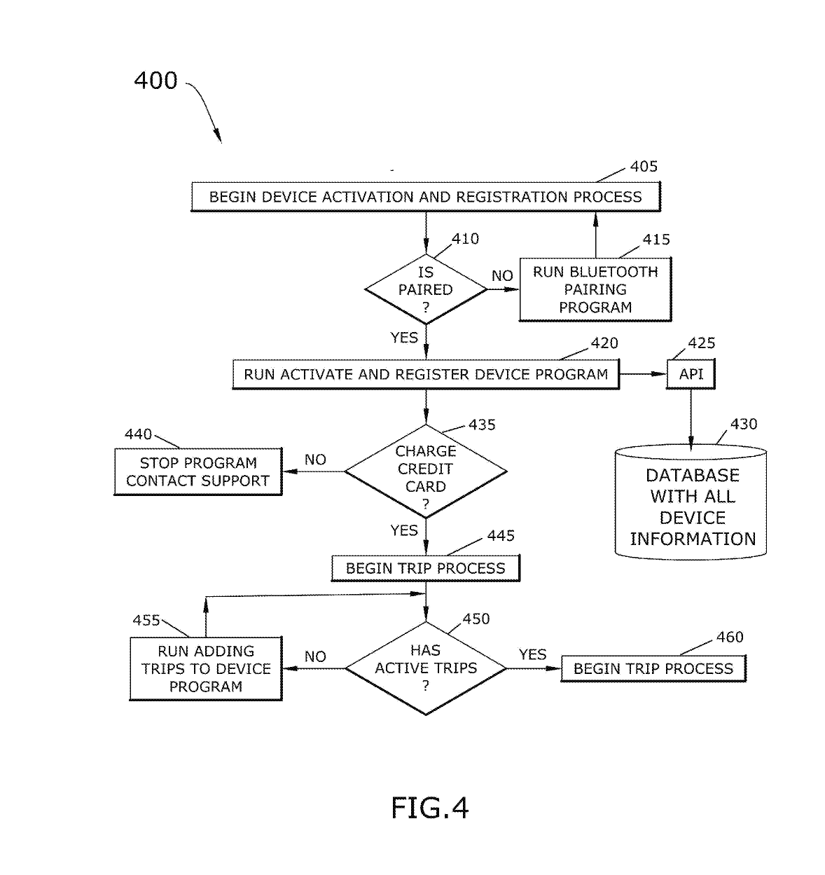

By way of example, FIG. 4 conceptually illustrates a personal luggage locator device activation and pairing process 400 for pairing a personal luggage locator device with a mobile device and activating the personal luggage locator device in relation to a trip. As shown in this figure, the personal luggage locator device activation and pairing process 400 starts by beginning (at 405) activation and registration of a personal luggage locator device and associated mobile device. Next, the personal luggage locator device activation and pairing process 400 determines (at 410) whether the personal luggage locator device is paired with the mobile device. When the personal luggage locator device is not paired with the mobile device, then the process 400 proceeds to run the Bluetooth® pairing program (at 415) and then transitions back to beginning (at 405) the activation and registration.

On the other hand, when the personal luggage locator device is determined (at 410) to be paired with the mobile device, then the personal luggage locator device activation and pairing process 400 proceeds to run (at 420) the activation and registration program to activate and register the personal luggage locator device. In some embodiments, a series of database API calls are made (at 425) to store the activation and registration information in a database 430 with all device information, with the activation and registration information associated with the personal luggage locator device.

In some embodiments, the personal luggage locator device activation and pairing process 400 next determines (at 435) whether to charge a credit card for a fee related to the activation and registration of the personal luggage locator device. When payment of the fee is refused (no credit card or alternative payment method), the process 400 stops (at 440) the program (and suggests to contact support).

On the other hand, when a credit card is charged, the process 400 then begins (at 445) the trip process. At this stage, the personal luggage locator device activation and pairing process 400 determines (at 450) whether there are any active trips saved in relation to the user. When no existing active trips are saved, the process 400 adds (at 455) trips to the personal luggage locator device program, and then returns to step 450 to determine whether there are any active trips. However, when there is at least one active trip saved, the process 400 then begins (at 460) the trip process.

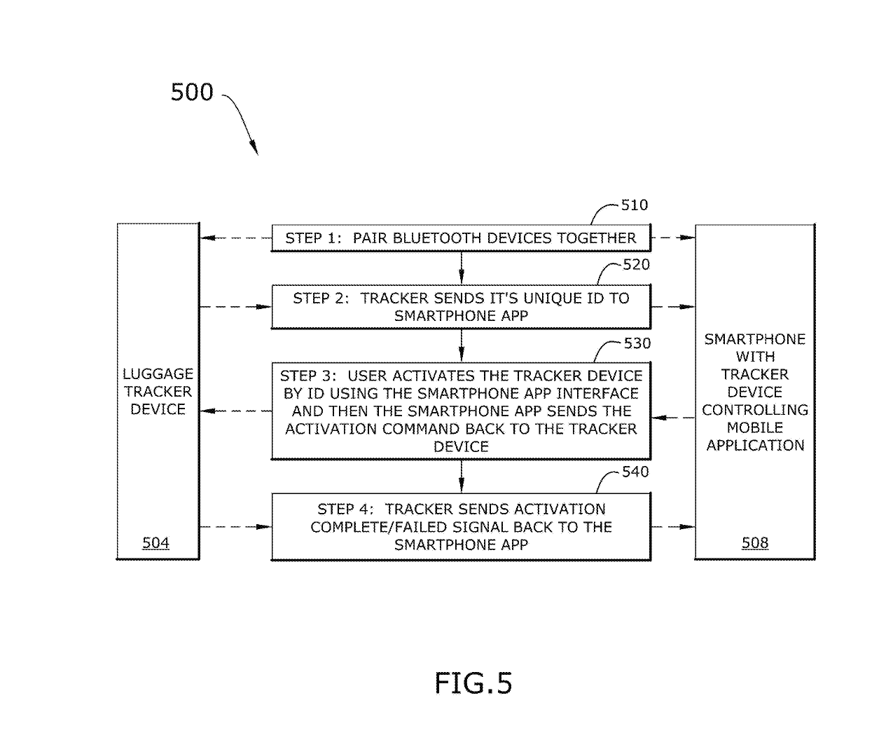

Turning now to FIG. 5, an active trip personal luggage locator device process 500 is conceptually illustrated. As shown in this figure, the active trip personal luggage locator device process 500 includes several steps which relate to the personal luggage locator device 504 and/or the mobile device 508 that is paired with the personal luggage locator device. Initially, the active trip personal luggage locator device process 500 performs Step 1 (at 510) to pair Bluetooth® devices together for the personal luggage locator device 504 and the mobile device 508. Next, the active trip personal luggage locator device process 500 performs Step 2 (at 520) in which the personal luggage locator device 504 sends its unique ID (or “UID”) to the mobile app running on the mobile device 508.

In some embodiments, the active trip personal luggage locator device process 500 next performs Step 3 (at 530) in which the traveler activates the personal luggage locator device 504 by its unique ID via the mobile app running on the mobile device 508. In some embodiments, the mobile app includes a graphical user interface (GUI) that allows the traveler to easily interact with the mobile app (e.g., by touch gestures on a touch-sensitive display screen of the mobile device). When this is complete, the mobile app then sends the activation command back to the personal luggage locator device 504. Next, the process 500 performs Step 4 (at 540) in which the personal luggage locator 504 sends one of an activation complete signal and an activation failed signal back to the mobile app running on the mobile device 508. Then the active trip personal luggage locator device process 500 ends.

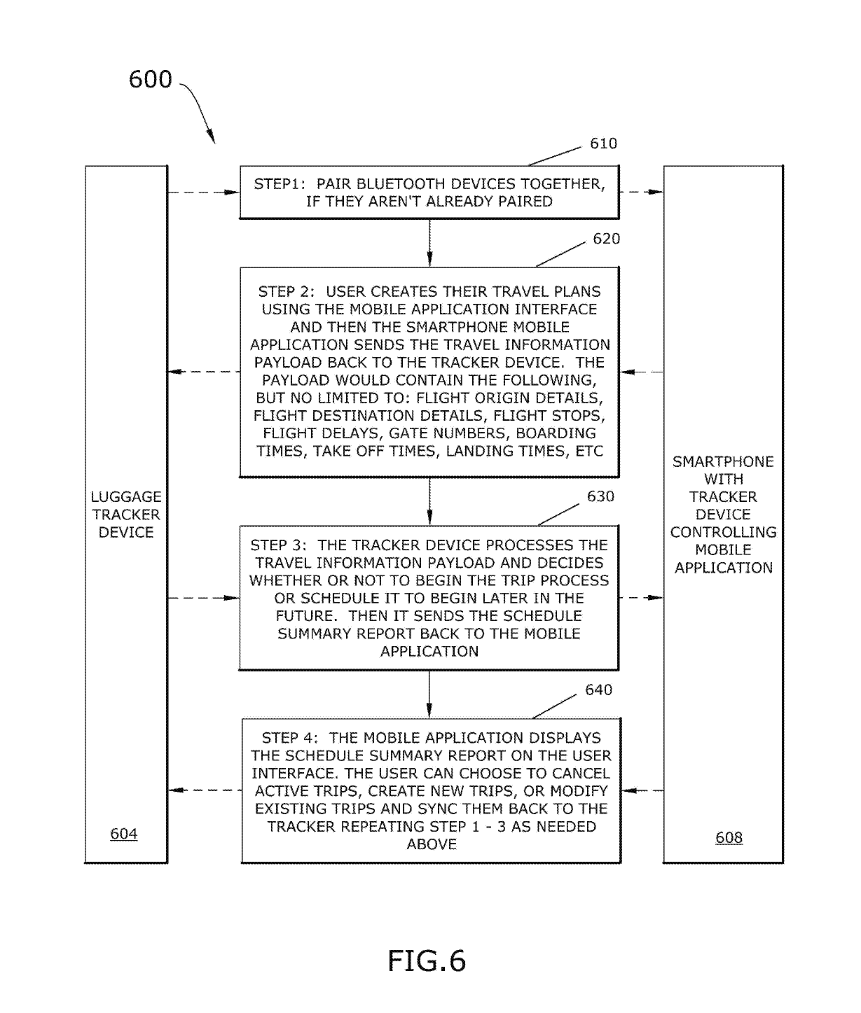

Another example of a process is shown in FIG. 6, which conceptually illustrates a schematic diagram of a process for adding trips and setting travel information in a personal luggage locator device 600. As shown in this figure, the process for adding trips and setting travel information in a personal luggage locator device 600 includes several steps which relate to the personal luggage locator device 604 and/or the mobile device 608 that is paired with the personal luggage locator device 604. Initially, the process for adding trips and setting travel information in a personal luggage locator device 600 performs Step 1 (at 610) to pair Bluetooth® devices together for the personal luggage locator device 604 and the mobile device 608, if they are not already paired. Next, the process for adding trips and setting travel information in a personal luggage locator device 600 performs Step 2 (at 620) in which the user creates travel plans using the mobile app running on the mobile device 608. The travel plans may be created via the GUI of the mobile app or by other means, for example, importing travel plans. When the travel plans are ready, the mobile app then sends information about the travel plans from the mobile device 608 back to the personal luggage locator device 604. The information about the travel plans may include, without limitation, flight origin details, flight destination details, flight stops/layovers, flight delays, gate numbers, boarding times, take off times, landing times, etc.

In some embodiments, the process for adding trips and setting travel information in a personal luggage locator device 600 next performs Step 3 (at 630) in which the personal luggage locator device 604 processes the information about the travel plans and decides whether or not to begin the trip process or schedule the trip to begin later in the future. In performing Step 3, the process for adding trips and setting travel information in a personal luggage locator device 600 of some embodiments also sends a schedule summary report from the personal luggage locator device 604 back to the mobile app running on the mobile device 608.

In some embodiments, the process for adding trips and setting travel information in a personal luggage locator device 600 next performs Step 4 (at 640) in which the mobile app running on the mobile device 608 displays the schedule summary report in the GUI. The user can choose to cancel active trips, create new trips, modify existing trips, and sync them back to the personal luggage locator device 604. To the extent needed, each of the steps (Step 1 at 610, Step 2 at 620, Step 3 at 630) may be repeated. When no more steps are needed, the process 600 ends.

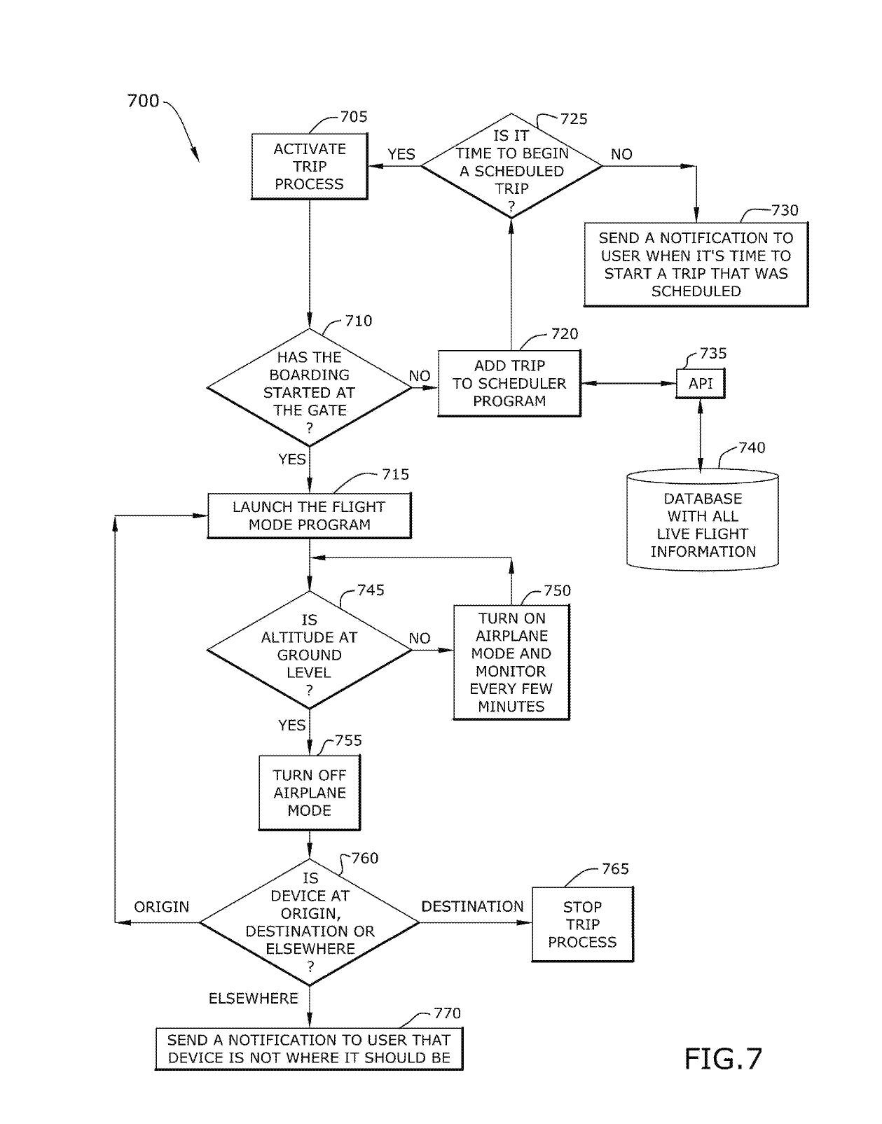

By way of example, FIG. 7 conceptually illustrates an active trip personal luggage locator device process 700 in some embodiments. As shown in this figure, the active trip personal luggage locator device process 700 starts by activating (at 705) a trip process. The process 700 then determines (at 710) whether boarding has started at the gate. When boarding has started, the process 700 launches (at 715) the “flight mode” program, which is described further below. On the other hand, when the process 700 determines that boarding has not started at the gate, the process 700 then adds (at 720) that trip to the scheduler program. When the trip is scheduled, the process 700 of some embodiments performs one or more database operations via an API 735 to save trip data in the database with all the live flight information 740.

In some embodiments, the active trip personal luggage locator device process 700 also determines (at 725) whether it is time to begin a scheduled trip or not. When it is not time to begin a scheduled trip, the process 700 then sends a notification (at 730) to the user when it is time to start a trip what was scheduled.

Returning to the process 700 step for launching (at 715) the flight mode program, in some embodiments, the process 700 determines (at 745) whether the altitude is at ground level according to the location coordinates of the GPS device. When the altitude is not at ground level, the process 700 then turns on (at 750) airplane mode and monitors every few minutes. On the other hand, when the altitude is at ground level, the process 700 then turns off (at 750) airplane mode. In some embodiments, the process 700 then determines (at 760) whether the device is at its origin, destination, or elsewhere. When the process 700 determines that the device is at the destination, the process 700 stops (at 765) the trip process. On the other hand, when the process 700 determines that the device is elsewhere, the process 700 then sends (at 770) a notification to the user that the device is not where it should be. Then the process 700 ends.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. For instance, several of the examples described in this specification relate to a personal luggage locator device, system, and processes, it is noted that embodiments of the personal luggage locator device, system, and processes are able to work with any manner of custodial care of bags, luggage, personal items, etc. This would therefore include, for example, bags, luggage, packages, gifts, etc., that are delivered over land (e.g., train delivery) or over sea (e.g., a cargo ship delivery with boxes, crates, and/or other such packaging).

Also, many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the terms “software”, “application”, “app”, and “mobile app” (referred to below as “software”) are meant to include firmware residing in read-only memory or applications stored in magnetic storage, which can be read into memory for processing by a processor, such as the processor of a mobile computing device or a mobile communication device, such as a smartphone, a hand-held computing device, or a tablet computing device (referred to simply as a “mobile device”), or the processor of a traditional computing device, such as a server computer, a desktop computer, or a laptop computer (referred to simply as a “computer”). Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

### IV. Electronic System

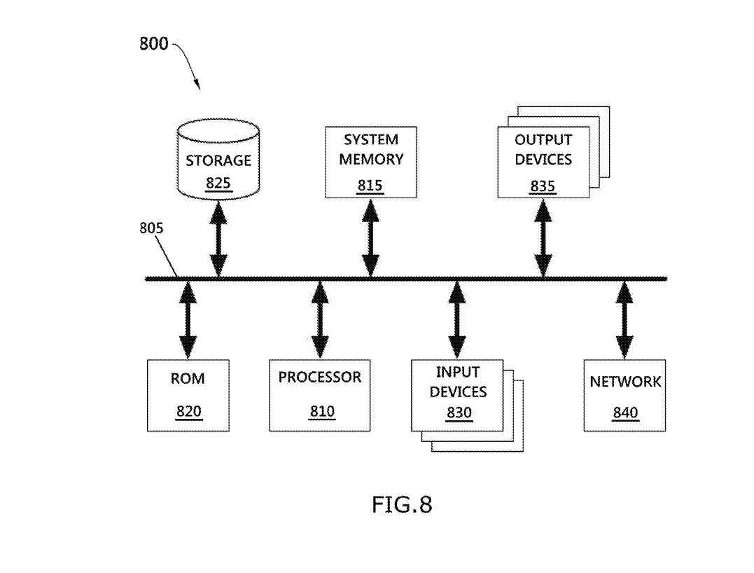

FIG. 8 conceptually illustrates an electronic system 800 with which some embodiments of the invention are implemented. The electronic system 800 may be a computer, mobile device, tablet, phone, PDA, or any other sort of electronic device. Such an electronic system includes various types of computer readable media and interfaces for various other types of computer readable media. Electronic system 800 includes a bus 805, processing unit(s) 810, a system memory 815, a read-only 820, a permanent storage device 825, input devices 830, output devices 835, and a network 840.

The bus 805 collectively represents all system, peripheral, and chipset buses that communicatively connect the numerous internal devices of the electronic system 800. For instance, the bus 805 communicatively connects the processing unit(s) 810 with the read-only 820, the system memory 815, and the permanent storage device 825.

From these various memory units, the processing unit(s) 810 retrieves instructions to execute and data to process in order to execute the processes of the invention. The processing unit(s) may be a single processor or a multi-core processor in different embodiments.

The read-only-memory (ROM) 820 stores static data and instructions that are needed by the processing unit(s) 810 and other modules of the electronic system. The permanent storage device 825, on the other hand, is a read-and-write memory device. This device is a non-volatile memory unit that stores instructions and data even when the electronic system 800 is off. Some embodiments of the invention use a mass-storage device (such as a magnetic or optical disk and its corresponding disk drive) as the permanent storage device 825.

Other embodiments use a removable storage device (such as a floppy disk or a flash drive) as the permanent storage device 825. Like the permanent storage device 825, the system memory 815 is a read-and-write memory device. However, unlike storage device 825, the system memory 815 is a volatile read-and-write memory, such as a random access memory. The system memory 815 stores some of the instructions and data that the processor needs at runtime. In some embodiments, the invention's processes are stored in the system memory 815, the permanent storage device 825, and/or the read-only 820. For example, the various memory units include instructions for processing appearance alterations of displayable characters in accordance with some embodiments. From these various memory units, the processing unit(s) 810 retrieves instructions to execute and data to process in order to execute the processes of some embodiments.

The bus 805 also connects to the input and output devices 830 and 835. The input devices enable the user to communicate information and select commands to the electronic system. The input devices 830 include alphanumeric keyboards and pointing devices (also called “cursor control devices”). The output devices 835 display images generated by the electronic system 800. The output devices 835 include printers and display devices, such as cathode ray tubes (CRT) or liquid crystal displays (LCD). Some embodiments include devices such as a touchscreen that functions as both input and output devices.

Finally, as shown in FIG. 8, bus 805 also couples electronic system 800 to a network 840 through a network adapter (not shown). In this manner, the computer can be a part of a network of computers (such as a local area network (“LAN”), a wide area network (“WAN”), or an intranet), or a network of networks (such as the Internet). Any or all components of electronic system 800 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, many of the drawings conceptually illustrate computer-based instruments and testing machines which facilitate the steps of one or more processes. In each case, the machine specific needs and testing requirements may necessitate that the specific operations of a process not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A personal luggage locator system that tracks luggage when a traveler is traveling via airline, said personal luggage locator system comprising:
a personal luggage locator computing device comprising a processor, a memory, a small digital display, a Bluetooth communication device, an embedded SIM card, a USB connection, a lithium-ion battery, and a solid state hard drive, wherein the personal luggage locator computing device is packed in a luggage item of the traveler;
a mobile computing device associated with the traveler, said mobile computing device comprising a mobile device processor, a mobile device memory, and a mobile application that finds a location of the traveler's luggage item by communicating with the personal luggage locator computing device via at least one of Bluetooth and the embedded SIM card;
a central database that stores communication data between the personal luggage locator device and the mobile computing device, said communication data comprising one or more of a device altitude, a user profile, and a set of device GPS location coordinates;
a web API that controls security access into the central database, receives data from the personal luggage locator computing device over the Internet, processes incoming data and data from the central database, and sends data to the personal luggage locator computing device over the Internet; and
a messaging center service comprising a software and hardware system that distributes digital information over the Internet or phone networks to all mobile computing devices with registered mobile applications that are active in the central database.

2. The personal luggage locator system of claim 1, wherein the lithium-ion battery is charged via the USB connection.

3. The personal luggage locator system of claim 1, wherein the personal luggage locator computing device is paired to the mobile computing device associated with the traveler.

4. The personal luggage locator system of claim 3, wherein the personal luggage locator computing device and the mobile computing device are paired by associating a unique ID of the personal luggage locator computing device with the mobile computing device.

5. The personal luggage locator system of claim 1, wherein the central database stores registration and activation data of the personal luggage locator computing device.

6. The personal luggage locator system of claim 1, wherein the small digital display comprises a touch-sensitive digital display screen.

7. The personal luggage locator system of claim 1, wherein the personal luggage locator computing device has a small form factor.

8. The personal luggage locator system of claim 7, wherein the small digital display comprises a small form factor touch-sensitive digital display screen.

9. The personal luggage locator system of claim 1, wherein altitude is determined by by trilateration with at least four GPS satellites.

10. The personal luggage locator system of claim 1, wherein the messaging center service provides a travel information to the mobile computing device, said travel information comprising at least one of flight origin details, flight destination details, flights stops, flight delays, gate numbers, boarding times, take off times, and landing times.
